(19) United States
(12) Patent Application Publication
(10) Pub. No.: US 2005/0103152 A1
(43) Pub. Date: May 19, 2005

(54) Speed control system for vehicles

(76) Inventors: Michael Frid, Medford, MA (US); Vili Korn, Mountainside, NJ (US)

Correspondence Address: Ilya Zborovsky, 6 Schoolhouse Way, Dix Hills, NY, 11746, US

(21) Appl. No.: 10/712,283

(22) Filed: Nov. 14, 2003

(51) Int. Cl. G05G 1/14

(52) U.S. Cl. 74/562

(57) ABSTRACT

A speed control system for a vehicle has a pedal displaceable by a foot of a user's leg so as to influence a corresponding action applied to a vehicle engine and thereby to increase and to reduce a vehicle speed, and an additional pedal which is spaced on the first mentioned and operatively connected with such first mentioned pedal, so that when one of the pedals is acted upon by the user's foot, the other of the pedals is also displaced substantially syncronomously, one of the pedals being located in an area reachable by the foot of the user's right leg, while the other pedal being located in an area reachable by the foot of a left leg of the user, and an operative connection of the two pedals with one another so as to provide their substantially syncronous movement.

### BACKGROUND OF THE INVENTION

The present application relates to systems for controlling speed of vehicles.

In vehicles, in particular ground vehicles such as cars, trucks, etc., the speed control system usually includes a pedal for controlling a fuel supply into the engine or a so-called “gas pedal,” and a braking pedal for braking the vehicle when necessary. The control of the speed of the vehicle is carried out by the above-mentioned gas pedal which is conventionally located at the right side of the braking pedal. When a vehicle is used for many hours, a driver gets tired and frequently feels that the gas pedal becomes “heavy.” The reason is that muscles of the right leg are fatigued, the driver's back is stressed, and other stresses are produced in a body as a result of a continuous application of a force to the gas pedal. It is believed that the existing speed control systems of vehicles can be improved to eliminate these disadvantages.

### SUMMARY OF THE INVENTION

Accordingly, it is an object of the invention to provide a speed control system for a vehicle which avoids the disadvantages of the prior art.

In keeping with these objects and with others which shall become apparent hereinafter, one feature of the present invention resides, briefly stated, in a gas control system for a vehicle which has two pedals spaced for one another in a horizontal direction so that one of said pedals is reachable by a foot of a right leg, while the other of the pedals is reachable by a foot of a left leg, and the pedals are formed so that regardless of which pedal is acted on by the user's foot, the pedals are displaced and control a fuel supply into a vehicle engine.

When the fuel control system is designed in accordance with the patent invention, a driver who feels that his right leg is tired, can operate the system with his left leg by applying an action on the pedal located substantially in the area of his left leg, so as to relieve the stress of his right leg. Also, drivers which have injuries to their legs, and drivers who are left-handed or left-legged or in other words for whom it is more comfortable to operate the system with the left leg, can use the additional pedal as well.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWING

FIG. 1 is a view schematically showing a speed control system for a vehicle in accordance with the present invention;

FIG. 2 is a cross section of one of the pedals of the inventive speed control system.

### DESCRIPTION OF THE PREFERRED EMBODIMENTS

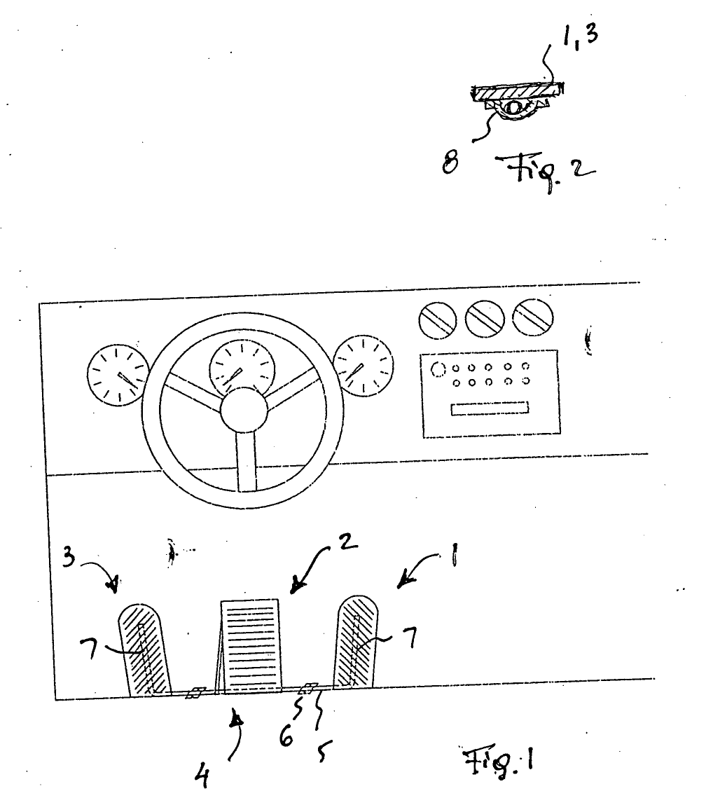

A speed control system in accordance with the present invention is schematically shown in FIG. 1, it includes a gas pedal identified as a whole as reference numeral 1. A braking pedal 2 is arranged near the gas pedal at its left side as is conventional in the majority of the contemporary vehicles. During driving, a driver applies a pressure onto the gas pedal 1 so as to supply more or less fuel into an engine of a vehicle, or to provide other types of control of the engine operation to increase or to reduce the speed of the vehicle. When it is necessary to brake, the driver applies a pressure to the brake pedal 2 so as to brake the vehicle.

In accordance with the present invention, an additional gas pedal 3 is provided. The gas pedal 3 is spaced from the gas pedal 1 in a horizontal direction. In particular, the gas pedal 1 is located in an area which is easily reachable by the foot of a right leg of the user, while the gas pedal 3 is provided in the area which is easily reachable by the foot of a left leg of the user.

The gas pedals 1 and 3 are operatively connected to one another, so a displacement of one of the pedals causes a displacement of the other pedal as well.

Therefore, in the inventive speed control system, when a driver acts on the gas pedal 1 with the foot of his right leg or when the driver acts on the gas pedal 3 with the foot of his left leg, the result is the same, namely, the speed of the vehicle increases or decreases.

During the operation of the inventive gas control system, the driver can control the fuel supply to the engine either by using exclusively his right leg, or by using exclusively his left leg, or by alternating the use of the right leg with the left leg if he feels fatigue in one of his legs.

In order to provide a substantially syncronomous operation of the pedals 1 and 3, the pedals are operatively connected to one another. In particular, as shown in the example presented in the drawings, they are connected to one another by a connecting element 4, which includes for example a central elongated rods extending in a horizontal direction and fixed to the vehicle, for example, to the vehicle floor, by clamps 6 which allow turning of the rod 5 inside the clamps around the axis of the rod, and two extensions 7 extending transversely from the rod 5 and each associated with a corresponding pedal 1 and 3.

Each of the rods 7 can be arranged slidably on a rear side of each of the pedals 1, 3, for example, in a guide 8 mounted on the rear surface of the pedal 1, 3. Only one of the pedals 1, 3 actually acts on a transmitting unit which transmits the displacement of the pedal to corresponding mechanisms to control the speed of the vehicle, for example by controlling the fuel supply to the engine. In accordance with the present invention, regardless of which of the pedals 1 and 3 is acted upon by the foot of the user, the second pedal also moves syncronomously. Thus, if the right pedal 7 directly controls the fuel supply to the engine, and the left pedal 7 is just connected to it, then when the left pedal 7 is acted upon by the foot of the user, the right pedal 7 is also displaced to provide a corresponding control of the engine.

When one of the pedals is acted on by the user's foot, its extension is displaced, the connecting rod 5 is turned, and the extension of the other pedal is displaced also, displacing the other pedal corresponding.

The connection of the pedals 7 with one another to provide a movement can be achieved in other ways as well. First of all, there can be mechanical connections between the pedals 1 and 3 which are different from the mechanical connections shown in the drawings. On the other hand, there can be an electrical or electronic connection between the pedals through corresponding electrical lines, so that when one of the pedals is acted on, an electrical signal is supplied to an actuating mechanism of the other pedal and the other pedal is displaced also by the actuating mechanism. Also, the signals can be transmitted remotely. For example, the pedals can be provided with transmitting and receiving means which remotely transmit and receive signals, so that when one of the pedals is actuated, the signal is supplied to the other pedal to displace it substantially syncronomously.

It is believed to be understood that the connection between the two pedals 1 and 3 is formed so as not to interfere with the operation of the brake pedal 2.

It will be understood that each of the elements described above, or two or more together, may also find a useful application in other types of constructions differing from the types described above.

While the invention has been illustrated and described as embodied in a title of the invention, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. A speed control system for a vehicle comprising a pedal displaceable by a foot of a user's leg so as to influence a corresponding action applied to a vehicle engine, and thereby to increase and to reduce a vehicle speed; and an additional pedal which is spaced from and operatively connected with such first mentioned pedal, so that when one of said pedals is acted upon by the user's foot, the other of said pedals is also displaced , one of said pedals being located in an area reachable by a foot of a user's right leg, while the other said pedal being located in an area reachable by a foot of a user's left leg; and means for operatively connecting said two pedals with one another so as to provide their substantial movement.

2. A speed control system for a vehicle as defined in claim 1; further comprising a braking pedal for braking the vehicle, said pedals being spaced from one another in a horizontal direction and being located at both sides of said braking pedal as considered in the horizontal direction.

3. A speed control system for a vehicle as defined in claim 1, where said connecting means include a mechanical connection which mechanically connects said pedals to one another.

4. A speed control system for a vehicle as defined in claim 3, wherein said mechanical connection includes a substantially horizontal rod pivotally attachable to a vehicle and two transverse extensions extending from ends of said rod and each associated with a respective one of said pedals, so that when one of said pedals is displaced, the corresponding one of said extensions is turned and through the rod the turning of one of the extensions is transmitted to the another of said extensions so that said other extension is also turned and displaces the other pedal.

5. A speed control system for a vehicle as defined in claim 3, wherein each of said pedals is provided in a slidable guide in which a corresponding one of said extensions can slide during displacement of said pedals.
